(19) United States
(12) Patent Application Publication
(10) Pub. No.: US 2015/0220584 A1
(43) Pub. Date: Aug. 6, 2015

(54) DYNAMIC MODIFICATION OF A DATABASE DATA STRUCTURE

(71) Applicant: CodeFutures Corporation, Broomfield, CO (US)

(72) Inventors: Cory M. Isaacson, Broomfield, CO (US); Andrew F. Grove, Broomfield, CO (US)

(21) Appl. No.: 14/613,356

(22) Filed: Feb. 3, 2015

Related U.S. Application Data
(60) Provisional application No. 61/935,301, filed on Feb. 3, 2014.

(51) Int. Cl. G06F 17/30

(52) U.S. Cl. CPC G06F 17/30336; G06F 17/30442; G06F 17/30516

(57) ABSTRACT

A self-optimizing database machine is provided in which data structures are evolved (e.g., added, dropped and changed) in response to database commands received from a client at a database. Algorithms may be pushed to one or more processors located at a drive and performed in parallel (e.g., via vector or other processing) to increase operational speed of a database. New or modified database structures and/or algorithms may be compiled into object code (e.g., native low-level assembler code that can be run directly on the processor) to be executed on a processor co-located or embedded in a storage device. New or modified database structures and/or algorithms may be dynamically loaded into the chip pathways as custom gate arrays (e.g., in an FPGA) at a component of a database system (e.g., a processor co-located or embedded in a storage device storing a shard or a collection of micro-shards of a database).

### CROSS-REFERENCE TO RELATED APPLICATIONS

This application claims the benefit of U.S. provisional patent application No. 61/935,301 filed by Cory Isaacson and Andrew Grove on Feb. 3, 2014, which is hereby incorporated by reference, including all appendices filed therewith, as if fully set forth herein.

This application is related to U.S. Pat. No. 8,626,709 issued to Cory Isaacson and Andrew Grove on Jan. 7, 2014, which is hereby incorporated by reference as though fully set forth herein.

### BACKGROUND

Query optimization has been performed in relational database systems. In these systems, a query optimizer attempts to determine an efficient way to execute a given query by executing a query plan to reduce the processing time of the query. The query plan is typically an automated process that attempts to optimize the query to reduce its processing time. The query plan is determined based on statistics of the data in the database, using an algorithm to pick the optimum plan given a database structure previously defined by a user of the database system. The database structure is defined as a data model, comprised of a table or similar structure, optionally in conjunction with indexes to improve performance. The user of the database must understand application requirements in order to create such a structure, and when application requirements change over time, the structure can become inefficient or unable to meet the requirements in terms of functionality or performance.

### BRIEF SUMMARY

In one implementation, a self-optimizing database machine is provided in which data structures are evolved (e.g., added, dropped and changed) and/or evolving data structures are suggested in response to database commands received from a client at a database. Further, algorithms may be pushed to one or more processors located at a drive and performed in parallel (e.g., via vector or other processing) to increase operational speed of a database. In one particular implementation, the new or modified database structures and/or algorithms may be compiled into object code (e.g., native low-level assembler code that can be run directly on the processor) to be executed on a processor co-located or embedded in a storage device. In another implementation the new or modified database structures and/or algorithms may be dynamically loaded into the chip pathways as custom gate arrays (e.g., in an FPGA) at a component of a database system (e.g., a processor co-located or embedded in a storage device storing a shard or a collection of micro-shards of a database).

In one implementation, a dynamic database system is provided including a non-transitory computer readable medium adapted for storing database data, wherein one or more data structures of the database or a stream view of the database is modified or created in response to monitoring database queries.

The foregoing and other aspects, features, details, utilities, and advantages of the present invention will be apparent from reading the following description and claims, and from reviewing the accompanying drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a block diagram of an example implementation of a sharded database system, such as may be used in an evolutionary or responsive database system as described herein;

FIG. 2 is a block diagram of another example of a sharded database system including a sharded database cluster system as described herein;

FIG. 3 is a block diagram of an example database stream in which one or more database commands are received from a client application and analyzed at a database as described herein;

FIG. 4 is a block diagram showing another example of a sharded database system in which database query commands from the client are directly provided to a database and/or to a stream view generated synchronously and/or asynchronously from the database as described herein;

FIG. 5 is a block diagram showing an example implementation of a stream engine that monitors and analyzes one or more database commands of a database as discussed herein;

FIG. 6 is a block diagram showing yet another example implementation of a database system in which one or more log files provide a database stream for analysis as described herein;

FIG. 7 is a flow chart showing an example process of dynamically monitoring operation of a database system and modifying data structures or suggesting modifications of data structures in the database in response to database commands, such as queries, received at the database from a client as described herein;

FIG. 8 is a block diagram illustrating example functions applied to data in a stream. In this example implementation, for example, a viewer Viewdb provides continuously updated snapshots of the updated stream output of the functions as described herein;

FIG. 9 is a block diagram illustrating an example pluggable view engine Viewdb that may be used to provide one or more snapshots of a database stream as described herein;

FIG. 10 is a block diagram illustrating an example implementation of a shard stripe approach as described herein; and

FIG. 11 is a block diagram illustrating an example computing device on which one or more database storage elements (e.g., database shards of a sharded database) may reside in whole or in part.

### DETAILED DESCRIPTION

In various implementations, a self-optimizing database machine is provided in which data structures are evolved (e.g., added, dropped and changed) in response to database commands received from a client at a database. Further, algorithms may be pushed to one or more processors located at a drive and performed in parallel (e.g., via vector or other processing) to increase operational speed of a database. In one particular implementation, the new or modified database structures and/or algorithms may be compiled into object code (e.g., native low-level assembler code that can be run directly on the processor) to be executed on a processor co-located or embedded in a storage device. In another implementation the new or modified database structures and/or algorithms may be dynamically loaded into the chip pathways as custom gate arrays (e.g., in an FPGA) at a component of a database system (e.g., a processor co-located or embedded in a storage device storing a shard or a collection of micro-shards of a database).

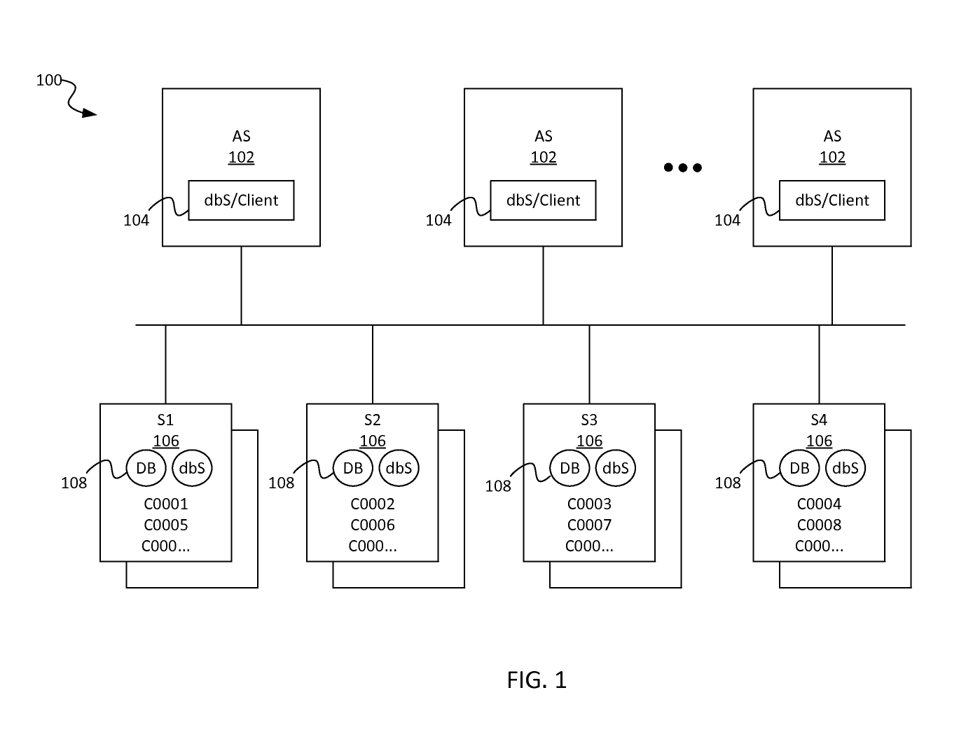

FIG. 1 shows an example implementation of a sharded database system 100, such as may be used in an evolutionary or responsive database system as described herein. It is important to note, however, that the sharded database system shown in FIG. 1 is merely one example database system. In the system shown in FIG. 1, a plurality of application servers (AS) 102 is configured supporting one or more database client module (dbS/Client) 104. The plurality of application servers (AS) 102 and, thus, the supported database client modules (dbS/Clients) 104 are coupled to a plurality of database shards (S1,S2,S3,S4, . . . Sn) 106 of a sharded database, such as, but not limited to, a sharded relational database. In the particular implementation shown in FIG. 1, for example, a first database shard S1 of a database (DB) 108 is sharded by a plurality of rows C0001, C0005, C0009, . . . ; a second database shard S2 of the database (DB) 108 is sharded by a second plurality of rows C0002, C0006, C0010 . . . ; a third database shard S3 of the database (DB) 108 is sharded by a third plurality of rows C0003, C0007, C0011, . . . ; and a fourth database shard S4 of the database (DB) 108 is sharded by a fourth plurality of rows, C0004, C0008, C0012, . . . . Again, the number of shards and rows within each shard is merely an example. Any number of sharding configurations may be used.

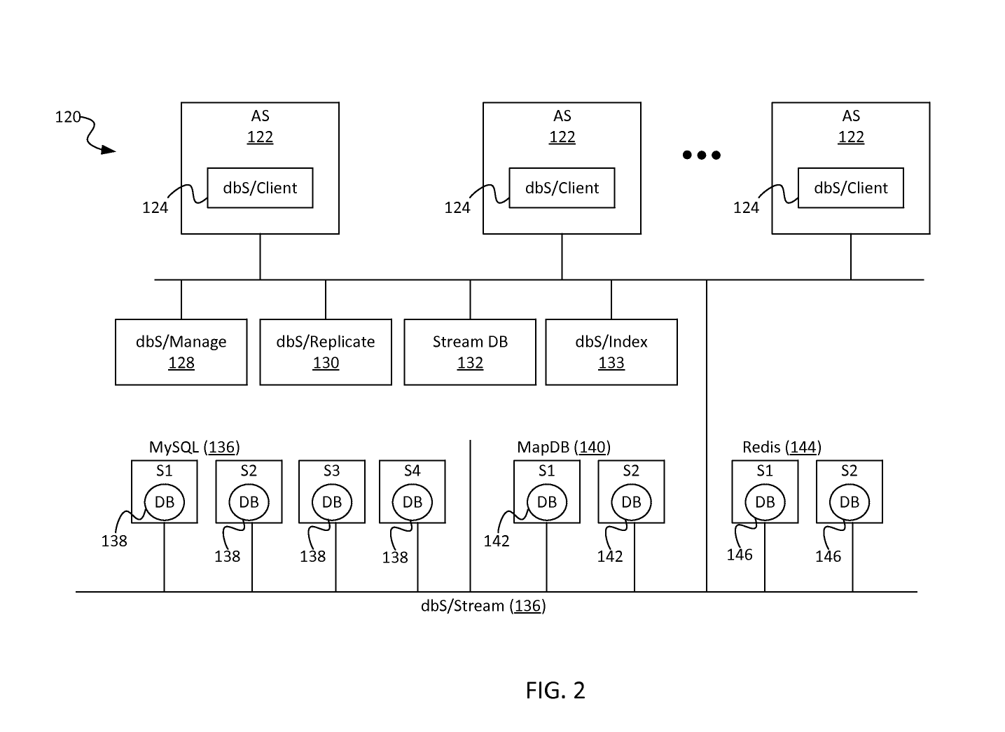

FIG. 2 shows another example of a sharded database system 120 in which the system comprises a sharded database cluster system. The example system shown in FIG. 2 again comprises a plurality of application servers (AS) 122 each supporting one or more database client module (dbs/Client) 124. The system further comprises a management Console 126, an administrative application connected to a management server (dbS/Manage) 128, which will be described in more detail herein. Each of the application servers 122 and, thus, the supported database client modules (dbS/Client) 124 are coupled to a database manager server (dbS/Manage) 128, a collection of one or more database replication servers (dbS/Replication) 130, a stream database server (dbS/StreamDB) 132 as well as a plurality of individually sharded databases 134. In various implementations, an indexing engine dbS/Index 133 (e.g., a third party indexing engine similar to Apache Lucene AL) may be used to populate and/or maintain an index.

In the particular example implementation shown in FIG. 2, for example, individually sharded databases comprise a MySQL database 136 comprising a plurality of database shards (S1,S2,S3,S4, . . . ) 138, a MapDB sharded database 140 comprising a plurality of database shards (S1,S2, . . . ) 142 and a Redis sharded database 144 comprising a plurality of database shards (S1,S2, . . . ) 146. These individual types of sharded databases are merely exemplary. As described above, each database may comprise any type of database including a sharded database (as shown), a relational sharded database, a micro sharded database, relational micro sharded database or the like. In one particular implementation, for example, one or more of the databases comprises an append-only log database.

In this implementation, the Manage server (dbS/Manage) 128 accumulates statistics on queries run against the database cluster 134, the statistics being collected by the Client (dbS/Client) 124 and/or by monitoring a database transaction log.

By analyzing the query statistics, the Manage server 128 may monitor for such things as repetitive or slow queries issued to one or more of the databases 134. Statistics such as measurement of repetitive or slow queries are then used to feed an algorithm, such as a heuristic algorithm, to generate or recommend database structures that best fit the query needs. In this implementation, the Manage server 128 will evaluate query patterns, query frequency, average execution time for a query pattern, maximum/minimum execution time for a query; any of these statistics may be used in determining the optimum storage structure for the data.

Where the database queries in the stream are not resolved or completed satisfactorily (e.g., within a predetermined time period, within a predetermined efficiency, etc.), the Manage server 128 can dynamically determine a new data structure for the database or for a stream view (e.g., StreamView) in order to provide a new data structure to optimize or otherwise improve the performance operation of the database query. The Manage server 128, for example, may dynamically determine and further dynamically change a data structure of a database and/or a stream view or dynamically create a new stream view to optimize or otherwise improve the operation of one or more database commands. The system 120 automatically will rebuild the data in the new structure. The Manage server 128 may also or alternatively dynamically determine a new or revised data structure for the database, stream view and/or a new stream view and identify or suggest a new stream view that is optimized or otherwise configured to improve the operation of the one or more database query. Thus, the dynamic data structures comprise a learning algorithm to constantly improve database performance, by matching data structures to the queries that are made of the database.

In contrast to a query optimizer, that optimizes or otherwise suggests or provides a different query, the manage server in this implementation is configured to alter or configure a new data structure (e.g., in the database or a stream view) to increase the speed, efficiency, or other operating parameter of a database command. This is done by creating one or more structures that match the queries being sent to the database cluster. In this manner, the actual data structure of a database or stream view is altered dynamically (or suggested dynamically) to improve one or more operating parameters of a database or stream view based on an analysis of one or more database queries. For example, where a particular query is repetitively received that fails to achieve a threshold or other requirement of a database (e.g., performed within a time threshold), a revised database structure may be determined that increases the performance of the database with respect to future iterations of that (or similar) database commands issued to the database and/or one or more stream views.

In various implementations of systems, such as the systems 100, 120 of FIGS. 1 and 2, for example, the sharded database system(s) (e.g., a sharded relational database) provide a scalable, high availability, recoverable (e.g., disaster recovery) system even in a situation where underlying infrastructure may not include scalable, high availability and/or recoverable components. The systems, in some implementations, may further provide consistent access and management for multiple database management system engines (e.g., SQL, NoSQL, NewSQL, In-Memory, etc.). The systems may also be configured to provide fast real-time analytic queries, operate with ad hoc analytics engines, provide real-time event processing (e.g., fire one or more automated events based on streaming data changes), and/or hands off automated management.

One or both of the systems shown in FIGS. 1 and 2, for example, may also provide automated cluster management, such as via a shard control language, a built-in version/deployment control, automated package management, server install and/or live schema changes; multi-domain support for combinations of a particular database management system and a sharding scheme; parser (e.g., full parser, parse-once architecture); stream view; indexing (e.g., recognize and shard based on a primary or other key); and advanced shard stripe sharding (e.g., to avoid or minimize re-sharding and/or add servers without re-sharding).

Replication in systems, such as systems 100, 120 shown in FIGS. 1 and 2, may also be done in accordance with many different replication techniques. In one particular implementation, for example, a replication technique such as one disclosed in U.S. Pat. No. 8,626,709 issued to Cory Isaacson and Andrew Grove on Jan. 7, 2014, which is hereby incorporated by reference in its entirety as if fully set forth herein, may be used. Other replication techniques may also be used. In another implementation, a collection of reliable replication servers are used to ensure replicate messages are fault tolerant, and can then be applied in parallel to one or more database servers. In various implementations, for example, continuous replication including a true “active-active” operation may be provided. Further, automated and/or planned failover may be provided.

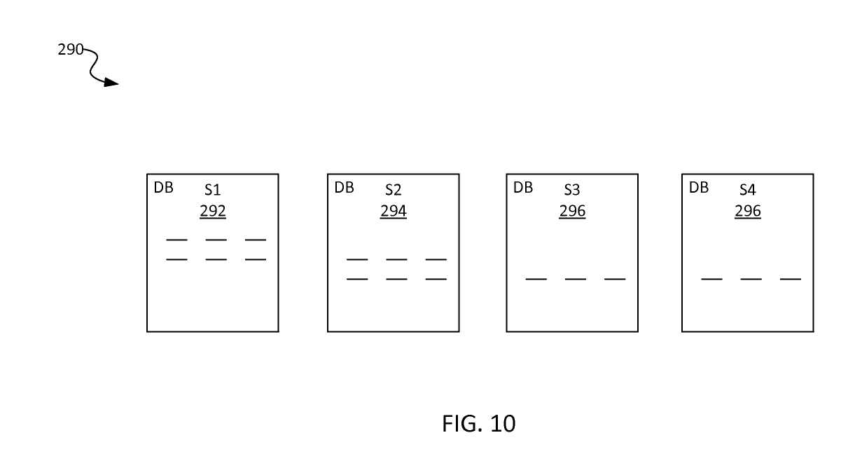

Further, advanced sharding techniques, such as shard stripes may be used to eliminate minimize re-balancing. In one implementation, for example, shard striping may work with a monotonic shard key and a consistent hash and/or an arbitrary shard key and consistent hash. An example of shard stripes is provided below with reference to FIG. 10.

In one implementation, data is written to a reliable replication or transaction log as the first step. This stores the actual data, including new, updated or deleted data in a single message in the reliable collection of replication servers (StreamEngine). The data is marked by a position within a shard, micro-shard, and file, such that it can be accessed rapidly when required after writing. In other implementations, this can be done by a sequence number of transactions within the stream, or other unique identifier. This is called the data producer stream. One or more data consumers subsequently read the data stream for one shard, micro-shard, or a collection of shards or micro-shards. The consumer then performs any operations on the data required to construct a dynamic data structure, or modify data within an existing dynamic data structure. The dynamic data structures are the stream views (StreamView) in this implementation.

In a specific implementation of the stream engine, network multiplexing, sharding, micro-sharding, and reliability are combined to provide efficiency and reliability in writing to the stream. Network multiplexing sends one or more data messages to the stream in a batch, and subsequently receives a batch of acknowledgements in return, indicating that the data has been written to the stream successfully and reliably. The data producer can write to one or more shards or micro-shards within the stream for portioning of the data. The reliability is provided by writing any stream message to at least two stream engine servers before acknowledging the write to the client.

A particular type of data in the stream may produce multiple stream views; each organized to optimize a specific query or queries. The stream view is distributed based on an optimized (or improved) pattern to provide improved performance for various application queries. This implementation ensures that all data is reliable, as the stream engine creates multiple copies of the data for each write. The processing of data by stream consumers into stream views can be performed in an asynchronous basis (i.e., the client does not wait for the stream view to be updated), or can be performed on a synchronous basis (i.e., the client does wait for the stream view to be updated). Each stream view maintains its position, for example, based on a last-acknowledged offset to an incoming log.

The system supports concurrent reads from the database, even if asynchronous updates to stream views are used. This is done by a) reading the data requested by the query from the stream view; b) reading the stream view position within the stream; and c) appending or applying any additional data that may reside in the stream that has not yet been applied to the stream view.

A stream view is comprised of a collection of one or more maps, which are data structures used to create a dynamic data structure. The maps are key-value pairs, or lists of data, and can be organized using any number of facilities provided for data storage optimization. These facilities can include indexes, customized views of the data, bitmap indexes, and column store formats. Thus a stream view can be created from one or more maps, each with a specific type of internal data structure, matching the needs of the application as closely as possible.

Dynamic changes to data structures (automated or suggested) can be used to provide a dynamic database and/or stream views for executing database commands in a relatively efficient manner. In many situations, for example, a database is not static, but rather is dynamic in which data and usage patterns change over time and new requirements for the database emerge. In the present application, various techniques are provided to dynamically change and/or suggest changes to the database or stream view data structure(s) for matching an application over time. The generated data structures can also be sharded (partitioned) to allow for scaling across many replication or shard servers, determining an optimized partitioning scheme that matches the application usage of the database based on query analytics as described above. Thus, existing data structures may be modified, dropped and/or replaced and new data structures added. Thus, flexible data structures as described herein can be designed to meet one or more needs one or more applications. A dynamic engine can be designed around Big Data streaming with built-in, automated scalability and reliability. In various implementations, for example, one or more components of the database may monitor a stream of database queries or transaction logs to provide the dynamic adjustment of data structures.

In one implementation, for example, one or more database structures, such as relational sharding, micro-sharding, partitioned data, partitioned indices or other data structures may be restructured on the fly (or database restructuring suggested for review by a database manager). For example, data structures and partitioning of data structures of the database or stream views may be restructured to increase or optimize single shard actions relative to multi-shard actions from database queries received. A database shard stream, in one implementation, for example, may analyze a database shard stream, summarize, aggregate or otherwise process information from the stream and then optimize one or more data structures of the database and/or shard streams. Thus the application requirements can be matched more closely, providing optimized performance and efficiency of the database system.

In one particular implementation, the analysis and/or revised programmatic code to access dynamic database structures can be performed at various locations/levels of a database system to increase the operational efficiency of the operations. These will be stored as compiled low-level access procedures, to perform one or many operations required to read from or write to a dynamic database structure. The procedure code to access dynamic database structures, for example, may be located (e.g., compiled into object code) to run on a processor co-located with a drive of a database. In one particular implementation, the procedure code algorithms (e.g., aggregation, vector processing, etc.) may be loaded into custom gate arrays in the chip itself, such as at an FPGA chip located at a particular component of a database system where the data structure is to be stored. Compiling, for example, may be implemented via a script, such as javascript, or other scripts to generate or alter a data structure on the fly.

The dynamic procedure algorithm used to access a dynamic data structure, for example, comprises a group of multiple database operations, such as, the following:
a multi-step write command;
a multi-step read command;
a distributed write command; and
a distributed read command.
   Performing multiple database operations through a single compiled procedure executing at the processor on the drive, or compiled into the processor on the drive, for the purpose of reading from, writing to, or performing a distributed operation to a dynamic data structure, eliminates multiple step invocations to the drive from the operating system. There are many layers between an operating system and a drive in a typical implementation, thus this approach has many fewer steps. Only one call to invoke a procedure to the processor on the drive is required, to perform all steps within the procedure in the drive itself.

Heuristics may also be used to analyze monitored queries from one or more database streams to determine a dynamic database structure in response to information included in a monitored database stream. In this way, any number of potential dynamic database structures can be evaluated in order to find the best performing option to satisfy queries from the stream.

Monitoring a database stream may be used to determine an optimized data structure, such as by monitoring one or more queries that are repetitively submitted to one or more databases (e.g., shard, micro-shards or other portions of the database).

Micro-shards may also be used along with parallel replication and/or parallel processing of database operations.

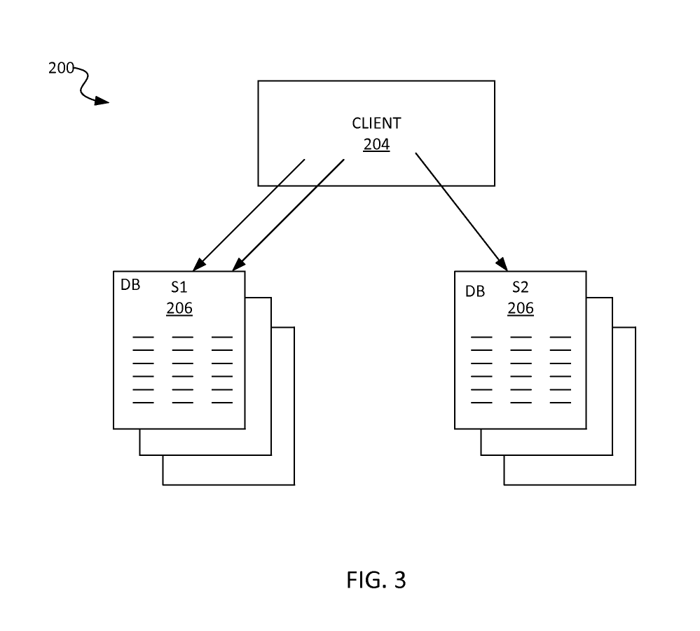

FIG. 3 shows a block diagram of an example database stream 200 in which one or more database commands 202 are received from a client application 204. The database commands 202 are received at a database 206 (e.g., the sharded database 206 shown in FIG. 3) and are analyzed at the database 206.

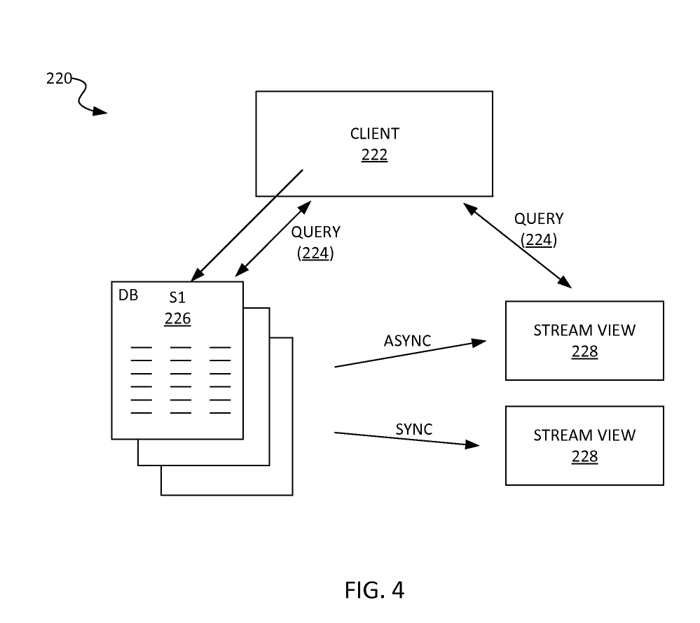

FIG. 4 is a block diagram showing yet another example of a sharded database system 220 in which database query commands from a client 222 are directly provided to a database 226 and/or to a stream view 228 generated synchronously and/or asynchronously from the database as described herein. In FIG. 4, for example, database query commands 224 from the client 222 may be directly provided to the database 226 and/or to a stream view 228 generated synchronously and/or asynchronously from the database 226.

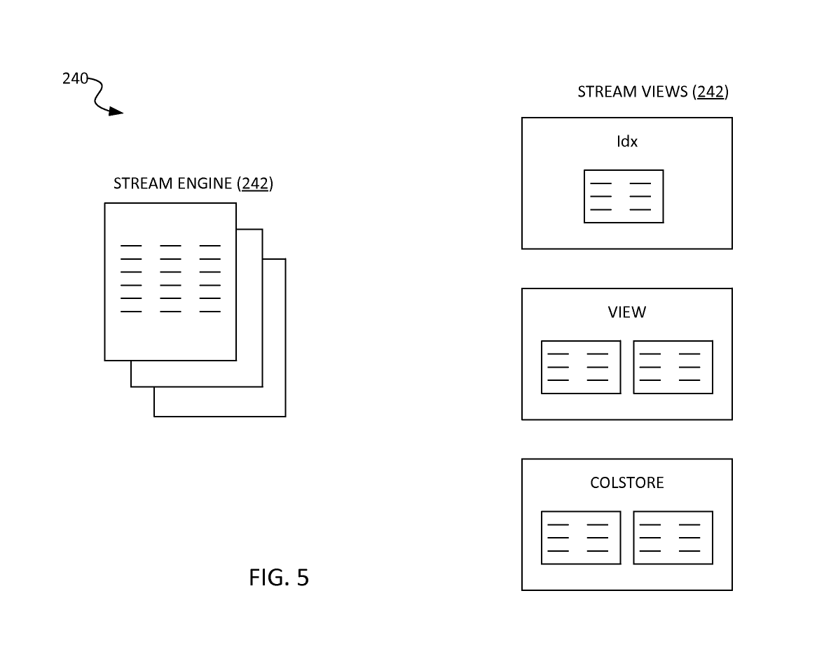

FIG. 5 shows an example implementation of a stream engine 240 that monitors and analyzes one or more database commands of a database as discussed herein. In this implementation, the stream engine 240 can monitor database commands directed to the database 242 and/or one or more stream views 244 (e.g., Idx, View and Colstore in this particular implementation).

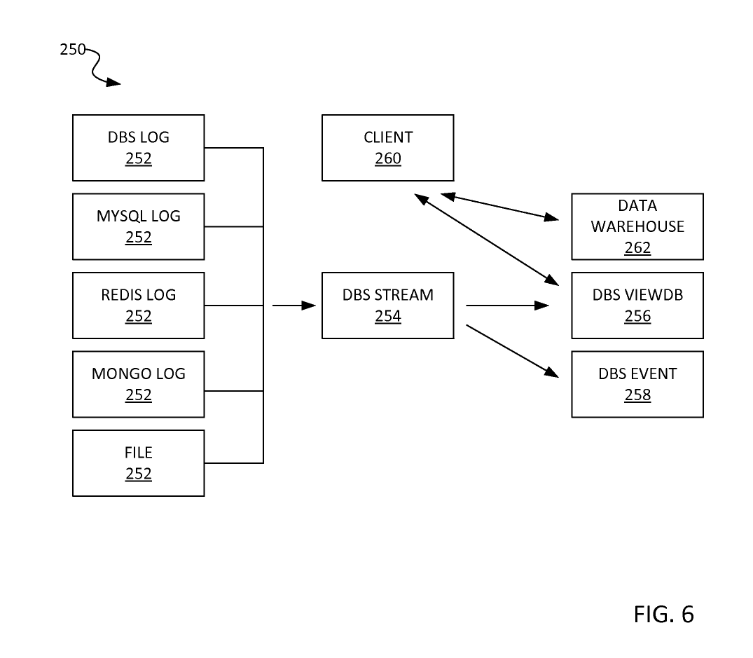

FIG. 6 shows yet another example implementation of a database system 250 in which one or more log files 252 (e.g., replication logs) provide a database stream 254 for analysis. Analysis of the database stream 254, for example, may be analyzed via a database viewer (e.g., dbS Viewdb 256) and/or a database event module (e.g., dbS Evebt 258). The database viewer 256, for example, may in some implementations provides a pluggable view engine, such as a MapDB wrapper layer. An event database, for example, may store information about view events as records in a database. Further, a database client 260 may communicate with a data warehouse 262 and the database viewer 256 and provide information between the data warehouse 262 and the database viewer 256.

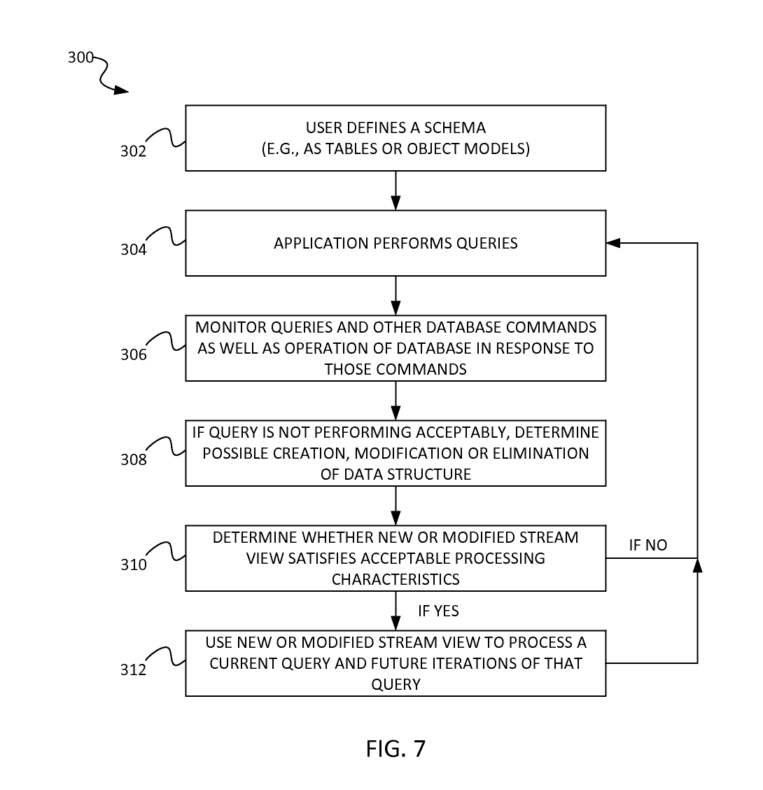

FIG. 7 shows one example of an example process 300 of dynamically monitoring operation of a database system and modifying data structures (or suggesting modifications to data structures) in the database in response to database commands, such as queries, received at the database from a client. In this process, one or more stream views can be linked to original table definitions of a database and can be used to derive which of a plurality of stream views is best or capable of handling a given database query command. The system (e.g., in a console server) can keep track of which table a stream view comes from, and then evaluate other characteristics such as, but not limited to, is the view summarized data or detail data, is it pre-joined to other tables or independent from other tables, if it is summarized, at what level or interval, and does that level or interval satisfy the query command? The understanding of particular data, its origin table definitions and stream view definitions allows the database system to understand a “chain” of how the data is manipulated to that it can best or efficiently match stream views and queries.

In this example process, a user defines a schema as tables or object models in operation (1). An application performs queries in operation 302. An application client, such as shown in FIGS. 1 and 2, for example, performs database queries and submits other commands to a database in operation 304. In operation 306 a console server or other monitoring component of the database system monitors the queries and other database commands as well as operation of the database in response to those commands.

If a particular query (e.g., a repetitive query submitted to the database in a stream of database commands) is not performing well (e.g., failing to be performed within a predetermined threshold range of response times or the like), the console server evaluates statistics such as by using heuristics, algorithms or other analytical techniques to create, modify or eliminate a stream view data structure in operation 308.

Where a particular query is not efficiently obtaining a result from a database, for example, a console server can use heuristic algorithms or other techniques to evaluate the query and the existing database structure. The console server can then determine a modified or new data structure of a stream view for optimally handling the repetitive query via a new or modified stream view. If an existing stream view is no longer warranted, such as due to changing database data, conditions or other factors, the out of date stream view may also be eliminated. If a new or modified stream view is determined to satisfy acceptable processing characteristics, it is used in operation 312 to process the query and future iterations of that query (or suggested as a possible data structure modification for future implementation).

In some implementations of the process, the process can be implemented in a cyclical manner so that after completion of operation 312 where a new stream view is defined and used or after an existing stream view is modified ad used or discarded, the process can loop back to operation 304 to monitor new queries. In other implementations multiple processes can be performed in parallel or in series.

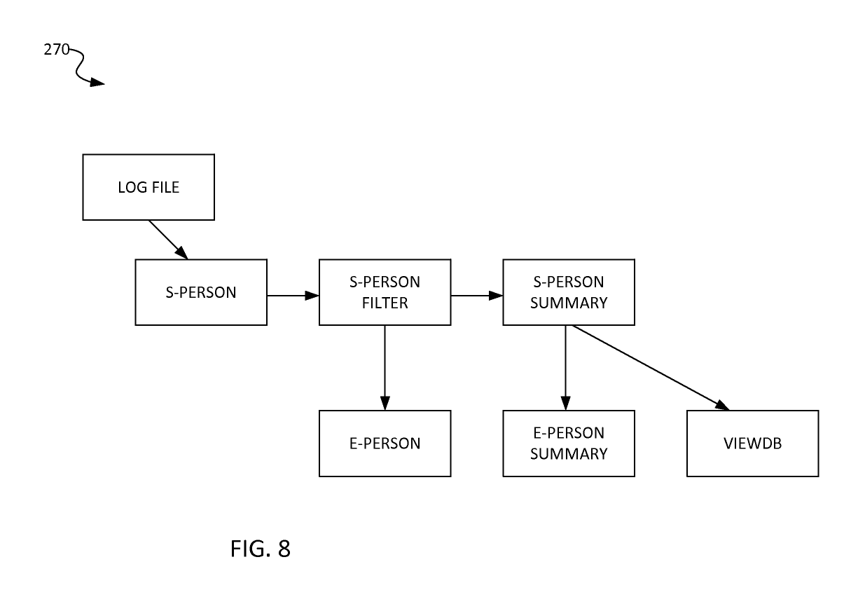

FIG. 8 is a block diagram illustrating example functions 270 applied to a stream of database commands. In this example implementation, for example, a viewer Viewdb provides continuously updated snapshots of the updated stream output of the functions. The functions shown in FIG. 8 are merely examples and can be implemented in a variety of contexts, languages or the like.

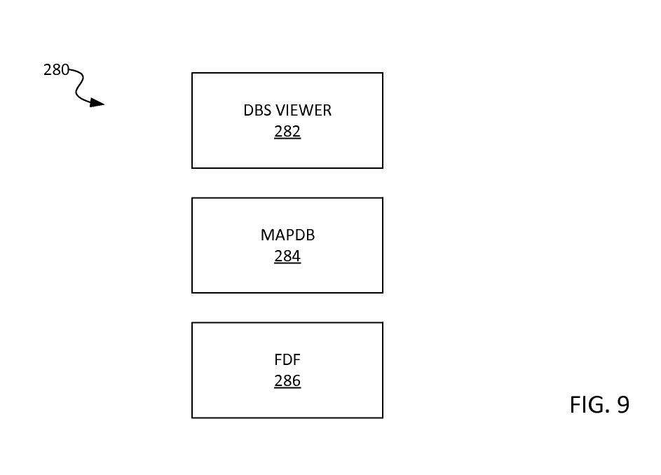

FIG. 9 is a block diagram illustrating an example pluggable view engine Viewdb 280 that may be used to provide one or more (e.g., continuously updated) snapshots of a database stream as described herein. In the particular implementation shown in FIG. 9, for example, the view engine 280 includes examples of MapDb and Forms Data Format (FDF) viewers, although other view engine implementations are also contemplated.

FIG. 10 is a block diagram illustrating an example implementation of a sharded database structure 290 using a shard stripe approach. In the implementation shown in FIG. 10, for example, a shard stripe approach provide for eliminating, minimizing or at least reducing re-balancing that may otherwise be needed in a database. In this implementation, shard stripe data structures are used. The shard stripe structure, in various implementations, work with a monotonic shard key and a consistent hash and/or an arbitrary shard key and consistent hash.

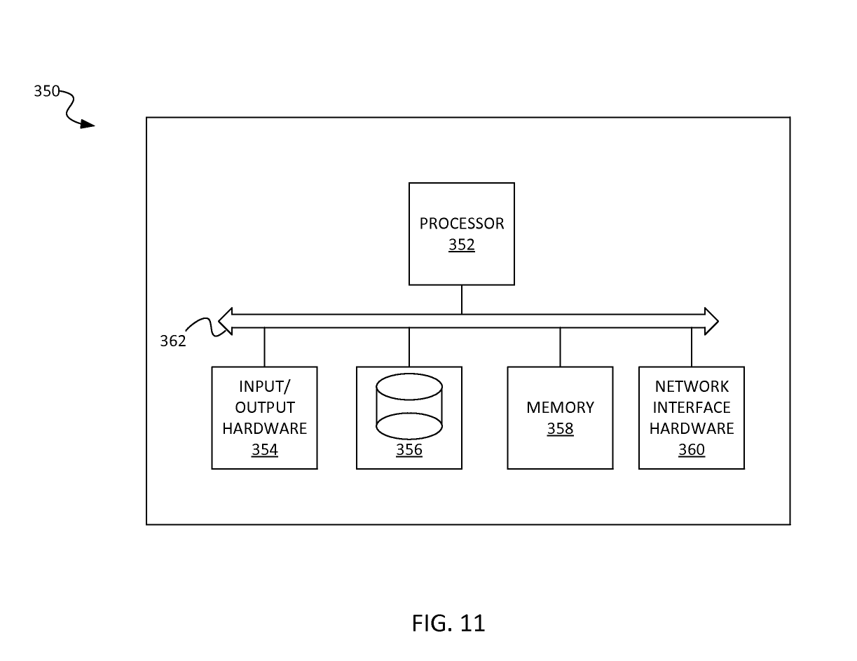

FIG. 11 is a block diagram illustrating an example computing device 350, such as a server or other computing device, on which one or more database shards of a sharded database may reside in whole or in part.

In one particular implementation, for example, the server 350 comprises a processor 352, input/output hardware, a non-transitory computer readable medium 354 configured to store data of a database, a non-transitory memory 356, network interface hardware 360. Each of these components are operably coupled via a local interface 362, which may be implemented as a bus or other interface to facilitate communication among the components of the server 350.

The non-transitory computer-readable medium component 356 and memory 358 may be configured as volatile and/or nonvolatile computer readable medium and, as such, may include random access memory (including SRAM, DRAM, and/or other types of random access memory), flash memory, registers, compact discs (CD), digital versatile discs (DVD), magnetic disks, and/or other types of storage components. Additionally, the non-transitory computer readable medium component 356 and memory component 358 may be configured to store, among other things, database data, analysis and/or revised programmatic code to access dynamic database structures. The analysis and/or revised programmatic code to access dynamic database structures, for example, can be performed at various locations/levels of a database system to increase the operational efficiency of the operations. In one particular implementation, for example, the analysis and/or revised programmatic code to access dynamic database structures may be stored as compiled low-level access procedures, to perform one or many operations required to read from or write to a dynamic database structure. The procedure code to access dynamic database structures, for example, may be located (e.g., compiled into object code) to run on a processor, such as the processor 352, co-located with a drive of a database. In one particular implementation, the procedure code algorithms (e.g., aggregation, vector processing, etc.) may be loaded into custom gate arrays in the chip itself, such as at an FPGA chip located at a particular component of a database system where the data structure is to be stored. Compiling, for example, may be implemented via a script, such as javascript, or other scripts to generate or alter a data structure on the fly.

The processor 352 may include any processing component configured to receive and execute instructions (such as from the memory component 358). The input/output hardware 354 may include any hardware and/or software for providing input to computing device 350, such as, without limitation, a keyboard, mouse, camera, sensor, microphone, speaker, touch-screen, and/or other device for receiving, sending, and/or presenting data. The network interface hardware 354 may include any wired or wireless networking hardware, such as a modem, LAN port, wireless fidelity (Wi-Fi) card, WiMax card, mobile communications hardware, and/or other hardware for communicating with other networks and/or devices.

It should be understood that the memory component 358 may reside local to and/or remote from the computing device 350 and may be configured to store one or more pieces of data for access by the computing device 350 and/or other components. It should also be understood that the components illustrated in FIG. 11 are merely exemplary and are not intended to limit the scope of this disclosure. More specifically, while the components in FIG. 11 are illustrated as residing within the computing device 350, this is a non-limiting example. In some implementations, one or more of the components may reside external to the computing device 350, such as within a computing device that is communicatively coupled to one or more computing devices.

Although embodiments of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A dynamic database system comprising:
a non-transitory computer readable medium adapted for storing database data,
wherein one or more data structures of the database or a stream view of the database is modified or created in response to monitoring database queries.

2. The dynamic database system of claim 1 wherein the data structure is modified or created automatically.

3. The dynamic database system of claim 1 wherein the modified or created data structure is provided for acceptance to a database administrator.

4. A self-optimizing database machine in which data structures are evolved in response to database commands received from a client at a database.

5. The self-optimizing database machine of claim 4 wherein the data structures are evolved via one or more of the group comprising: added, dropped and changed.

6. The self-optimizing database machine of claim 4 wherein algorithms are pushed to one or more processors located at a drive and performed in parallel to increase operational speed of a database.

7. The self-optimizing database machine of claim 6 wherein the algorithms are pushed to the one or more processors via a vector.

8. The self-optimizing database machine of claim 4 wherein a new or modified database structure and/or algorithms are compiled into object code (e.g., native low-level assembler code that can be run directly on the processor) to be executed on a processor co-located or embedded in a storage device.

9. The self-optimizing database machine of claim 5 wherein a new or modified database structure and/or algorithms are compiled into object code (e.g., native low-level assembler code that can be run directly on the processor) to be executed on a processor co-located or embedded in a storage device.

10. The self-optimizing database machine of claim 6 wherein a new or modified database structure and/or algorithms are compiled into object code (e.g., native low-level assembler code that can be run directly on the processor) to be executed on a processor co-located or embedded in a storage device.

11. The self-optimizing database machine of claim 4 wherein the new or modified database structures and/or algorithms may be dynamically loaded into the chip pathways as custom gate arrays (e.g., in an FPGA) at a component of a database system (e.g., a processor co-located or embedded in a storage device storing a shard or a collection of micro-shards of a database).

12. A process for modifying a database structure comprising:
perform database queries and submits other commands to a database;
monitors the queries, other database commands and operation of the database in response to those commands;
determine whether the query is meeting one or more predetermined criteria;
evaluate statistics to create, modify or eliminate a stream view data structure; and
determine whether a new or modified stream view satisfies the predetermined criteria.

13. The process of claim 12 further comprising using the new or modified stream view to process a future query.

14. The process of claim 12 further comprising providing the new or modified stream view for further implementation.
